(19) United States
(12) Patent Application Publication
(10) Pub. No.: US 2012/0033631 A1
(43) Pub. Date: Feb. 9, 2012

(54) Method, Apparatus and System for Controlling Working Mode of HSDPA System

(75) Inventor: Dingzhang Dai, Shanghai (CN)

(73) Assignee: HUAWEI TECHNOLOGIES CO., LTD., Shenzhen (CN)

(21) Appl. No.: 13/269,949

(22) Filed: Oct. 10, 2011

Related U.S. Application Data
(63) Continuation of application No. 12/763,871, filed on Apr. 20, 2010.
Application No. 12/763,871 is a continuation of application No. PCT/CN2008/072993, filed on Nov. 10, 2008.

(30) Foreign Application Priority Data
Nov. 9, 2007 (CN) 200710188203.8

(51) Int. Cl. H04W 74/00

(52) U.S. Cl. 370/329

(57) ABSTRACT

A method for controlling a working mode of a high speed downlink packet access (HSDPA) system includes steps as follows. When an activation state of a high speed shared control channel (HS-SCCH) less operation mode needs to be changed, a base station transmits a physical layer signaling for activating or deactivating the HS-SCCH less operation mode to a user equipment (UE), so as to instruct the UE to activate or deactivate the HS-SCCH less operation mode. The UE activates or deactivates the HS-SCCH less operation mode according to the physical layer signaling for activating or deactivating the HS-SCCH less operation mode from the base station.

This application is a continuation of U.S. patent application Ser. No. 12/763,871, filed Apr. 20, 2010, which is a continuation of International Application No. PCT/CN2008/072993, filed Nov. 10, 2008, which claims priority to Chinese Patent Application No. 200710188203.8, filed Nov. 9, 2007, each of which is incorporated herein by reference in its entirety.

### TECHNICAL FIELD

The present invention relates to a high speed downlink packet access (HSDPA) technique, and more particularly to a method, an apparatus, and a system for controlling a working mode of an HSDPA system.

### BACKGROUND

An HSDPA technique is a downlink high speed data solution in a wideband code division multiple access (WCDMA) system. A high speed shared control channel (HS-SCCH) is introduced into the HSDPA technique, in which HS-SCCH is a downlink control channel and is configured to bear control information and orders, etc. When a base station (NodeB) transmits downlink data, in order to reduce signaling overhead on the HS-SCCH, an HS-SCCH less operation mode is proposed in the industry, but when the NodeB does not transmit the downlink data, the system needs not to work under the HS-SCCH less operation mode.

In order to switch a working mode of the HSDPA system, a method for controlling the working mode of the HSDPA system by adopting a high-level signaling configuration manner exists in the prior art. Through this method, the NodeB and a user equipment (UE) may enter the HS-SCCH less operation mode or exit the HS-SCCH less operation mode. The high-level signaling refers to a Layer 3 signaling in the WCDMA system. In the method for controlling the working mode of the HSDPA system by adopting the high-level signaling configuration manner, particularly, a radio network controller (RNC) respectively initiates a configuration signaling to the NodeB and the UE, so as to configure the NodeB and the UE to enter the HS-SCCH less operation mode or a common mode. After the NodeB and the UE are synchronized, the configuration becomes effective.

### SUMMARY OF THE INVENTION

The inventor of the application finds through the research that in the solution, a signaling interaction process of the RNC and the NodeB, a signaling interaction process of the RNC and the UE, and a synchronization process of the uplink and the downlink need to consume a certain period of time, and the total consumed time is measured in seconds, and this reveals that a configuration speed of this manner is much slower. Before the configuration becomes effective, the UE still needs to execute the complex determining and receiving processes, the processing on the UE side is complex, and the processing resource overhead is large. In addition, during the signaling interaction process of the technical solution, air interface resource overhead is generated.

Various embodiments of the present invention provide a method for controlling a working mode of an HSDPA system so that fast control of the working mode of the HSDPA system may be implemented and therefore system resources may be saved.

Various embodiments of the present invention provide a base station for controlling a working mode of an HSDPA system so that fast control of the working mode of the HSDPA system may be implemented and therefore system resources may be saved.

Various embodiments of the present invention provide a UE for controlling a working mode of an HSDPA system so that fast control of the working mode of the HSDPA system may be implemented and therefore system resources may be saved.

Various embodiments of the present invention provide an HSDPA system for controlling a working mode of an HSDPA system so that fast control of the working mode of the HSDPA system may be implemented and therefore system resources may be saved.

The method for controlling a working mode of an HSDPA system includes determining whether an activation state of an HS-SCCH less operation mode of the HSDPA system needs to be changed.

If the activation state of the HS-SCCH less operation mode needs to be changed, a physical layer signaling is transmitted to a UE, so as to instruct the UE to activate or deactivate the HS-SCCH less operation mode. The physical layer signaling is preset, or is generated after it is determined that the activation state of the HS-SCCH less operation mode of the HSDPA system needs to be changed.

Network side equipment includes a determining unit, a signaling generating unit, and a first communication unit.

The determining unit is configured to determine whether an activation state of an HS-SCCH less operation mode of an HSDPA system needs to be changed.

The signaling generating unit is configured to generate a physical layer signaling or invoke a preset physical layer signaling for activating or deactivating the HS-SCCH less operation mode, when the activation state of the HS-SCCH less operation mode needs to be changed.

The first communication unit is configured to transmit the physical layer signaling for activating or deactivating the HS-SCCH less operation mode to a UE, so as to instruct the UE to activate or deactivate the HS-SCCH less operation mode.

A method for controlling a working mode of an HSDPA system is described now.

A physical layer signaling, from a network side, for activating or deactivating an HS-SCCH less operation mode is received.

The HS-SCCH less operation mode is activated or deactivated according to the physical layer signaling for activating or deactivating the HS-SCCH less operation mode.

A UE includes a second communication unit and an activation state executing unit.

The second communication unit is configured to receive a physical layer signaling, from a network side, for activating or deactivating an HS-SCCH less operation mode.

The activation state executing unit is configured to activate or deactivate the HS-SCCH less operation mode, according to the physical layer signaling for activating or deactivating the HS-SCCH less operation mode.

An HSDPA system includes the network side equipment according to the embodiments of the present invention and the UE according to the embodiments of the present invention.

It may be known from the technical solution that in the technical solution that the working mode of the HSDPA system is controlled through the physical layer signaling according to the embodiments of the present invention, when the activation state of the HS-SCCH less operation mode needs to be changed, the physical layer signaling for activating or deactivating the HS-SCCH less operation mode is transmitted to the UE, and the UE activates or deactivates the HS-SCCH less operation mode of the UE side, according to the physical layer signaling for activating or deactivating the HS-SCCH less operation mode. As compared with the solution in the prior art that the HSDPA system is made to enter or exit the HS-SCCH less operation mode by adopting the high-level signaling, the solution of the present invention that the HS-SCCH less operation mode is activated or deactivated by adopting the physical layer signaling has a higher speed, so as to quickly control the working mode of the HSDPA system, so that when the NodeB determines to deactivate the HS-SCCH less operation mode, the UE may quickly know the activation state of the HS-SCCH less operation mode of the NodeB side, thereby preventing the meaningless complex determination, and saving processing resources of the UE. Furthermore, air interface resources are further saved in the configuration adopting the physical layer signaling as compared with the configuration adopting the high-level signaling interaction.

### BRIEF DESCRIPTION OF THE DRAWINGS

FIG. 1 is a schematic flow chart of a method for controlling a working mode of an HSDPA system according to an embodiment of the present invention;

FIG. 2 is a schematic structural view of a network side equipment for controlling the working mode of the HSDPA system according to an embodiment of the present invention; and

FIG. 3 is a schematic structural view of a UE for controlling the working mode of the HSDPA system according to an embodiment of the present invention.

### DETAILED DESCRIPTION OF ILLUSTRATIVE EMBODIMENTS

An HSDPA technique is a downlink high speed data solution in a WCDMA (Wideband Code Division Multiple Access) system. Three channels, including an HS-SCCH, a high speed physical downlink shared channel (HS-PDSCH), and a high speed dedicated physical control channel (HS-DPCCH), are introduced in the HSDPA technique. The HS-SCCH is a downlink control channel and is configured to bear control information and orders, etc., in which the control information is used for demodulating data on an associated traffic channel. The HS-PDSCH is a downlink traffic channel and is configured to bear the data, in which the data may be demodulated according to the control information on the associated control channel. The HS-DPCCH is an uplink dedicated physical channel and is configured to bear three physical layer signals including an acknowledgement message (ACK), a non-acknowledgement message (NACK), and a channel quality indicator (CQI). The HS-SCCH, the HS-PDSCH, and the HS-DPCCH adopt a transmission time interval of 2 ms.

A technical solution of controlling a working mode of an HSDPA system through a physical layer signaling is provided in an embodiment of the present invention. In this solution, when an activation state of an HS-SCCH less operation mode needs to be changed, for example, when it is not necessary to transmit the data in the HS-SCCH less operation mode, the physical layer signaling for deactivating the HS-SCCH less operation mode is transmitted to the UE, and then the UE deactivates the HS-SCCH less operation mode of the UE side according to the physical layer signaling for deactivating the HS-SCCH less operation mode. When it is necessary to transmit the data in the HS-SCCH less operation mode, the physical layer signaling for activating the HS-SCCH less operation mode is transmitted to the UE, so as to instruct the UE to activate the HS-SCCH less operation mode in time. The physical layer signaling for activating or deactivating the HS-SCCH less operation mode may be preset, or may also be generated after it is determined that the activation state of the HS-SCCH less operation mode needs to be changed. If the physical layer signaling is preset, in the operation of setting the physical layer signaling, the physical layer signaling may be set and stored when establishing the link of the UE or during the reconfiguration. Subsequently, when it is necessary to use the physical layer signaling, the physical layer signaling may be directly invoked.

As compared with the conventional solution that the HSDPA system is made to enter or exit the HS-SCCH less operation mode by adopting the high-level signaling, the solution of the embodiments of the present invention that the HS-SCCH less operation mode is activated or deactivated by adopting the physical layer signaling has a higher speed, so as to quickly control the working mode of the HSDPA system, so that the UE may quickly know the activation state of the HS-SCCH less operation mode of the NodeB side, thereby preventing the meaningless complex determination, and saving processing resources of the UE. On the other hand, air interface resources are further saved in the configuration adopting the physical layer signaling as compared with the configuration adopting the high-level signaling interaction.

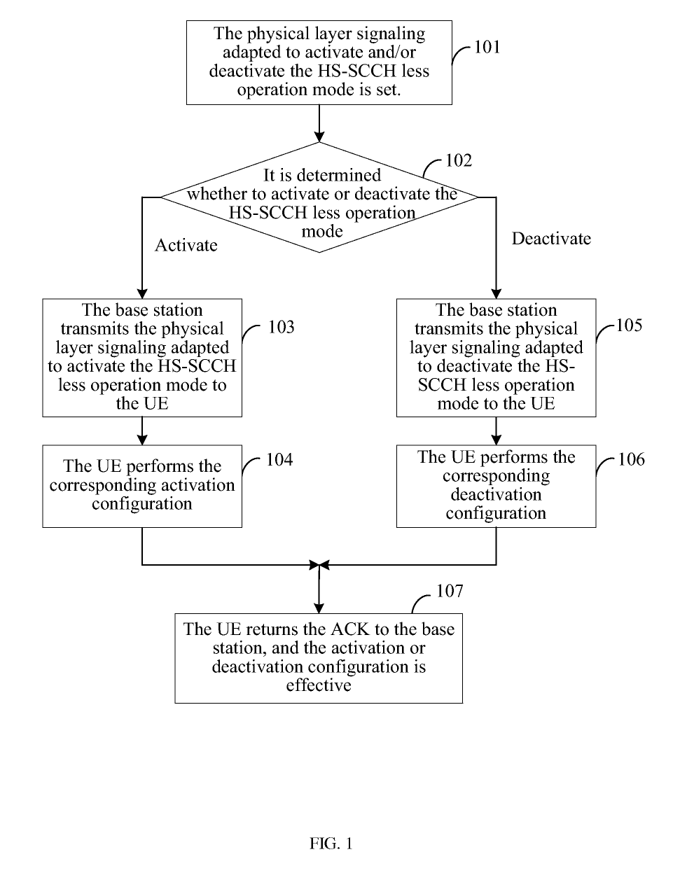

Referring to FIG. 1, the particular implementation manner of the method for controlling the working mode of the HS-SCCH according to an embodiment of the present invention is described as follows.

In step 101, the physical layer signaling for activating and/or deactivating the HS-SCCH less operation mode is preset.

The physical layer signaling may be set by a plurality of manners, for example, expanding the existing physical layer signaling or increasing a new physical layer signaling. One implementation manner is performing expansion on the basis of the existing HS-SCCH order. In order to facilitate the description of the manners of setting the physical layer signaling for activating and/or deactivating the HS-SCCH less operation mode, it is necessary to describe the HS-SCCH control information.

When the HSDPA system works under the HS-SCCH less operation mode, the NodeB transmits the data in two manners including a cyclic redundancy check code (CRC) attachment method 1 and a CRC attachment method 2 of the HS-PDSCH. Correspondingly, the NodeB transmits two types of control information including HS-SCCH type 1 control information and HS-SCCH type 2 control information. In addition to the type 1 control information and the type 2 control information, the control information borne on the HS-SCCH further includes type M control information. The difference among the three types of HS-SCCH control information is that information bits mapped to the HS-SCCH are different.

For the HS-SCCH type 1 control information, after the control information is mapped to the HS-SCCH, the HS-SCCH includes the information bits as follows:

1) Channelization-code-set information, 7 bit, respectively being represented as Xccs,1, Xccs,2, . . . , Xccs,7;

2) Modulation scheme information, 1 bit, being represented as Xms,1;

3) Transport-block size information, 6 bit, being represented as Xtbs,1, Xtbs,2, . . . , Xtbs,6;

4) Hybrid-ARQ process information, 3 bit, being represented as Xhap,1, Xhap,2, Xhap,3;

5) Redundancy and constellation version, 3 bit, being represented as Xrv,1, Xrv,2, Xrv,3;

6) New data indicator, 1 bit, being represented as Xnd,1;

7) UE identify, 16 bit, being represented as Xue,1, Xue,2, . . . , Xue,16.

When the information bits are respectively set according to the values as follows, it represents that the corresponding order is currently transported on the HS-SCCH.

1) Xccs,1, Xccs,2, . . . , Xccs,7 and Xms,1 are set to “11100000”;

2) Xtbs,1, Xtbs,2, . . . , and Xtbs,6 are set to “111101”;

3) Xhap,1, Xhap,2, Xhap,3, Xrv,1, Xrv,2, Xrv,3 are set to Xodt,1, Xodt,2, Xodt,3, Xord,1, Xord,2, Xord,3.

The three bits including Xodt,1, Xodt,2, Xodt,3 represent an order type, and when the Xodt,1, Xodt,2, and Xodt,3 are of different values, different order types are represented.

Xord,1, Xord,2, and Xord,3 represents different orders under a certain order type.

Currently, there is an already defined order type 000, that is, Xodt,1, Xodt,2, and Xodt,3 are set to “000”, and under this order type, the mapping situations of the order are as follows.

Xord,1 is a discontinuous reception (DRX) order activation bit.

Xord,2 is a discontinuous transmission (DTX) order activation bit.

Xord,3 is a reservation bit.

In the step, on the basis of the order, the physical layer signaling for activating the HS-SCCH less operation mode and/or the physical layer signaling for deactivating the HS-SCCH less operation mode are expanded. In this embodiment, the introduction is given by setting the two manners as follows as an example, but it is not limited to the two manners.

For the first manner, the reservation bit of the order having an order type of 000 is served as the bit of activating or deactivating the HS-SCCH less operation mode of this embodiment, and represents or indicates whether to activate or deactivate the HS-SCCH less operation mode.

It is regulated that when the order type is 000, and the bit of activating or deactivating the HS-SCCH less operation mode is set to the value indicating performing the activation, for example, a first value, the order of activating the HS-SCCH less operation mode is represented.

When the order type is 000, and the bit of activating or deactivating the HS-SCCH less operation mode is set to the value being different from the value indicating performing the activation, for example, a value different from the first value indicating performing the activation, the order of deactivating the HS-SCCH less operation mode is represented.

Usually, the bit set to “1” represents that a certain function is activated, and the bit set to “0” represents that a certain function is deactivated. Therefore, the first value may be “1”, and correspondingly, the value being different from the first value may be “0”.

In this manner, Xhap,1, Xhap,2, Xhap,3, Xrv,1, Xrv,2, Xrv,3 are set to “000**1”, which represents the order of activating the HS-SCCH less operation mode.

Xhap,1, Xhap,2, Xhap,3, Xrv,1, Xrv,2, Xrv,3 are set to “000**0”, which represents the order of deactivating the HS-SCCH less operation mode. The “*” represents a random value.

Of course, the manner of setting the bits may be inversed.

For example, Xhap,1, Xhap,2, Xhap,3, Xrv,1, Xrv,2, Xrv,3 are set to “000**0”, which represents the order of activating the HS-SCCH less operation mode.

Xhap,1, Xhap,2, Xhap,3, Xrv,1, Xrv,2, Xrv,3 are set to “000**1”, which represents the order of deactivating the HS-SCCH less operation mode.

For the second manner, one order type is increased, and the bit for activating or deactivating the HS-SCCH less operation mode is set in the added order type.

For example, an order type 001 may be increased, and Xord,1 under this order type serves as the bit of activating or deactivating the HS-SCCH less operation mode.

It is regulated that when the order type is 001, and the bit of activating or deactivating the HS-SCCH less operation mode is set to the value indicating performing the activation, for example, a second value, the order of activating the HS-SCCH less operation mode is represented.

When the order type is 001, and the bit of activating or deactivating the HS-SCCH less operation mode is set to the value being different from the value indicating performing the activation, for example, a value different from the second value indicating performing the activation, the order of deactivating the HS-SCCH less operation mode is represented.

Similarly, the second value may be “1”, and the value being different from the second value may be “0”.

In this manner, Xhap,1, Xhap,2, Xhap,3, Xrv,1, Xrv,2, Xrv,3 are set to “0011**”, which represents the order of activating the HS-SCCH less operation mode.

Xhap,1, Xhap,2, Xhap,3, Xrv,1, Xrv,2, Xrv,3 are set to “0010**”, which represents the order of deactivating the HS-SCCH less operation mode.

In step 102, when the UE in the HSDPA system has the HS-SCCH less operation function, that is, the UE is configured as HS-SCCH_less mode=1, if the HS-SCCH less operation mode needs to be activated, the process proceeds to step 103, and if the HS-SCCH less operation mode needs to be deactivated, the process proceeds to step 105.

For the particular operation, for example, it is determined whether the activation state of the current HS-SCCH less operation mode of the UE needs to be changed or not. If the activation state of the current HS-SCCH less operation mode needs to be changed, it is determined whether the HS-SCCH less operation mode needs to be activated or deactivated. If the HS-SCCH less operation mode needs to be activated, the process proceeds to step 103. If the HS-SCCH less operation mode needs to be deactivated, the process proceeds to step 105. Further, if it is determined that the activation state of the HS-SCCH less operation mode needs not to be changed, the subsequent processing is not performed.

In step 103, the base station transmits the physical layer signaling for activating the HS-SCCH less operation mode to the UE.

In this step, the base station transmits the physical layer signaling for activating the HS-SCCH less operation mode to the UE, according to the setting in step 101.

In step 104, the UE performs the corresponding activation configuration according to the physical layer signaling for activating the HS-SCCH less operation mode from the base station; the process proceeds to step 107.

An HS-SCCH less operation mode indication bit may be set in the UE, so as to instruct the UE to activate or deactivate the HS-SCCH less operation mode, and different values of the indication bit indicate the activation states of the current HS-SCCH less operation mode of the UE. The indication bit may be a Boolean variable, and different Boolean values indicate the activation states of the current HS-SCCH less operation mode. The indication bit may also be a common variable, and different values indicate the activation states of the current HS-SCCH less operation mode.

For example, a Boolean variable HS-SCCH_less mode activation may be set.

It is appointed that when HS-SCCH_less mode activation=true, it represents that the current HS-SCCH less operation mode is the activation state.

When HS-SCCH_less mode activation=false, it represents that the current HS-SCCH less operation mode is the deactivation state.

Here, the operation of “performing the corresponding activation configuration” in this step may be setting the HS-SCCH_less mode activation to “true”.

In step 105, the base station transmits the physical layer signaling for deactivating the HS-SCCH less operation mode to the UE.

In this step, the base station transmits the physical layer signaling for deactivating the HS-SCCH less operation mode to the UE according to the setting in step 101

In step 106, the UE performs the corresponding deactivation configuration according to the physical layer signaling for deactivating the HS-SCCH less operation mode from the base station.

Referring to the setting in step 104, the operation of “performing the corresponding deactivation configuration” may be setting the HS-SCCH_less mode activation to “false”.

In step 107, the UE returns the acknowledgement message ACK to the base station, after the base station receives the ACK, the activation or deactivation configuration is effective, that is, the HS-SCCH less operation mode of the base station side is activated or deactivated corresponding to the physical layer signaling transmitted to the UE. Then, the HSDPA system works according to the configuration state. In addition, the UE returns a non-acknowledgement message NACK to the base station, after the base station receives the NACK message, the activation state of the HS-SCCH less operation mode of the base station side is not changed, that is, the activation or deactivation configuration is not effective, and the HSDPA system works according to the original state.

In this step, the UE returns the ACK to the UE through the HS-DPCCH, so as to represent that the UE side correspondingly sets the activation state of the HS-SCCH less operation mode. The HS-DPCCH is an uplink dedicated physical channel introduced by the HSDPA technique, and is configured to bear three types of physical layer signals including ACK, NACK, and CQI.

During the practical application, the UE may also not return the ACK to the base station, but enables the activation or deactivation configuration to become effective according to the manner as follows.

For example, an effective time is pre-appointed, after the base station transmits the physical layer signaling for activating or deactivating the HS-SCCH less operation mode, a timer having a timing length being the effective time may be started. The physical layer signaling transmitted from the base station includes time stamp information, after the UE receives the physical layer signaling transmitted from the base station, the timer having the timing length being “effective time−(current time−time represented by the time stamp information)” is started according to the current time, the time stamp information in the physical layer signaling, and the pre-appointed effective time, and when the respective timer is timed out, it is considered that the effective time is reached, so the activation or deactivation configuration is effective.

During the practical application, in step 103 or 105, upon receiving the physical layer signaling of the base station, the UE returns the ACK to the base station, then the activation or deactivation configuration of the UE side is performed, and the configuration immediately becomes effective or becomes effective after waiting for a certain period of time.

During the practical application, the physical layer signaling for activating or deactivating the HS-SCCH less operation mode may not be preset, but the physical layer signaling for activating the HS-SCCH less operation mode is generated before step 104, or the physical layer signaling for deactivating the HS-SCCH less operation mode is generated before step 106. That is, the corresponding physical layer signaling is generated when the activation state of the HS-SCCH less operation mode of the HSDPA system needs to be changed. For the manner of generating the physical layer signaling for activating or deactivating the HS-SCCH less operation mode, please refer to the setting manner of step 101.

It can be known from the technical solution that the technical solution of controlling the working mode of the HSDPA system in the present invention is realized through the physical layer signaling. When the activation state of the HS-SCCH less operation mode needs to be changed, the preset physical layer signaling for activating or deactivating the HS-SCCH less operation mode is directly transmitted to the UE, and the UE activates or deactivates the HS-SCCH less operation mode of the UE side, according to the physical layer signaling for activating or deactivating the HS-SCCH less operation mode. As compared with the solution in the prior art that the HSDPA system is made to enter or exit the HS-SCCH less operation mode by adopting the high-level signaling, the solution of the present invention that the HS-SCCH less operation mode is activated or deactivated by adopting the physical layer signaling has a higher speed, so as to quickly control the working mode of the HSDPA system, so that when the NodeB determines to deactivate the HS-SCCH less operation mode, the UE may quickly know the activation state of the HS-SCCH less operation mode of the NodeB side, thereby preventing the meaningless complex determination, and saving the processing resources of the UE. On the other hand, air interface resources are further saved in the configuration adopting the physical layer signaling as compared with the configuration adopting the high-level signaling interaction.

The present invention further provides a method for controlling the working mode of the HSDPA system of the UE side. In this method, the physical layer signaling for activating or deactivating the HS-SCCH less operation mode from the network side is received, and the HS-SCCH less operation mode is activated or deactivated according to the received physical layer signaling for activating or deactivating the HS-SCCH less operation mode. The particular realization manner may, for example, include the steps as follows.

In a first step, the physical layer signaling for activating or deactivating the HS-SCCH less operation mode from the network side (for example, the base station) is received.

In a second step, a determination is performed according to the physical layer signaling, if it is determined that the HS-SCCH less operation mode needs to be activated, the process proceeds to a third step, and if it is determined that the HS-SCCH less operation mode needs to be deactivated, the process proceeds to a fourth step.

In the third step, the UE performs the corresponding activation configuration, that is, activates the HS-SCCH less operation mode, according to the physical layer signaling for activating the HS-SCCH less operation mode from the network side.

An HS-SCCH less operation mode indication bit may be preset in the UE, so as to instruct the UE to activate or deactivate the HS-SCCH less operation mode. The indication bit may be a Boolean variable, and different Boolean values indicate the activation states of the current HS-SCCH less operation mode. The indication bit may also be a common variable, and different values indicate the activation states of the current HS-SCCH less operation mode. For the particular setting process, please refer to the realizing method according to the embodiment as shown in FIG. 1.

For example, a Boolean variable HS-SCCH_less mode activation may be set.

It is appointed that when HS-SCCH_less mode activation=true, it represents that the current HS-SCCH less operation mode is the activation state.

When HS-SCCH_less mode activation=false, it represents that the current HS-SCCH less operation mode is the deactivation state.

The operation of “performing the corresponding activation configuration” in the step may be setting the HS-SCCH less operation mode indication bit to the value indicating performing the activation according to the physical layer signaling. For example, the HS-SCCH less mode activation is set to “true”.

In the fourth step, the UE performs the corresponding deactivation configuration according to the physical layer signaling for deactivating the HS-SCCH less operation mode from the network side, so as to deactivate the HS-SCCH less operation mode.

Referring to the setting in the third step, in this step, the operation of “performing the corresponding deactivation configuration” on the HS-SCCH less operation mode includes the processes. According to the physical layer signaling, the HS-SCCH less operation mode indication bit is set to the value being different from the value indicating performing the activation, and the HS-SCCH less operation mode is deactivated according to the deactivation indication of the indication bit, for example, the HS-SCCH_less mode activation is set to “false”.

After the HS-SCCH less operation mode is activated or deactivated, the method further includes the steps as follows.

In a fifth step, the acknowledgement message ACK is given as a feedback to the network side, so that the configuration with respect to the activation state of the HS-SCCH less operation mode becomes effective, in which giving the ACK to the network side as the feedback represents that the UE side correspondingly sets the activation state of the HS-SCCH less operation mode.

During the practical application, upon receiving the physical layer signaling of the network side, the UE returns the ACK to the base station, then the activation or deactivation configuration is performed on the UE side, and the configuration immediately becomes effective or becomes effective after waiting for a certain period of time.

During the practical application, the UE may also not return the ACK to the base station, but enable the activation or deactivation configuration to become effective according to the manner as follows.

For example, an effective time is pre-appointed, after the base station transmits the physical layer signaling for activating or deactivating the HS-SCCH less operation mode, a timer having a timing length being the effective time may be started. The physical layer signaling transmitted from the base station includes time stamp information, and after the UE receives the physical layer signaling transmitted from the base station, the timer having the timing length being “effective time−(current time−time represented by the time stamp information)” is started according to the current time, the time stamp information in the physical layer signaling, and the pre-appointed effective time. When the respective timer is timed out, it is considered that the effective time is reached, and the activation or deactivation configuration is effective.

The particular implementation manner of the network side equipment according to the present invention, for example, the base station, the UE, and the HSDPA system is described with reference to the accompanying drawings.

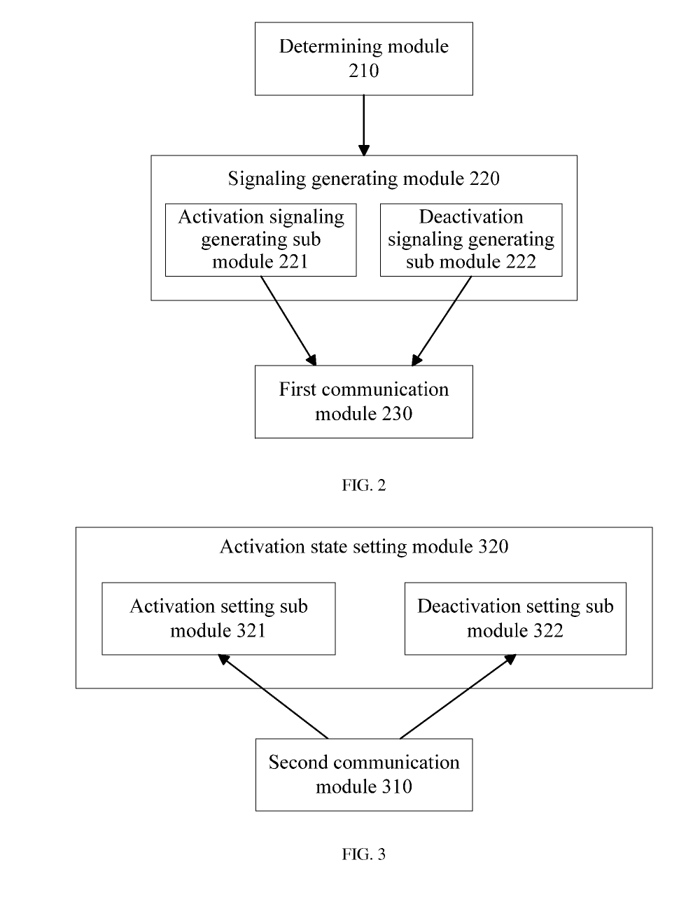

Referring to FIG. 2, a schematic structural view of the network side equipment (e.g., base station) for controlling the working mode of the HSDPA system according to the present invention is shown. The network side equipment (base station) includes a determining module or unit 210, signaling generating module or unit 220, and a first communication module or unit 230.

The determining unit 210 is configured to determine whether the activation state of the HS-SCCH less operation mode of the HSDPA system needs to be changed or not.

The signaling generating unit 220 is configured to generate a physical layer signaling or invoke the preset physical layer signaling for activating or deactivating the HS-SCCH less operation mode, when the activation state of the HS-SCCH less operation mode needs to be changed.

The first communication unit 230 is configured to transmit the physical layer signaling for activating or deactivating the HS-SCCH less operation mode to a UE, so as to instruct the UE to activate or deactivate the HS-SCCH less operation mode.

The signaling generating unit 220 as shown in FIG. 2 includes at least one sub unit, namely, an activation signaling generating sub unit 221 or a deactivation signaling generating sub unit 222. The activation signaling generating sub unit 221 is configured to generate a physical layer signaling or invoke the preset physical layer signaling for activating the HS-SCCH less operation mode, when the HS-SCCH less operation mode needs to be activated. The deactivation signaling generating sub unit 222 is configured to generate a physical layer signaling or invoke the preset physical layer signaling for deactivating the HS-SCCH less operation mode, when the HS-SCCH less operation mode of the HSDPA system needs to be deactivated.

The particular manner of constructing the physical layer signaling for activating or deactivating the HS-SCCH less operation mode may be obtained with reference to the embodiment of the method, so it is not repeated here.

In the network equipment according to the present invention, the first communication unit is further configured to receive the acknowledgement message ACK or NACK as the feedback given by the UE. If the ACK is received, the activation or deactivation operation is performed on the HS-SCCH less operation mode of the base station side corresponding to the physical layer signaling transmitted to the UE, according to the received ACK.

Referring to FIG. 3, a schematic structural view of the UE for controlling the working mode of the HSDPA system according to the present invention is shown. The UE includes a second communication module or unit 310 and an activation state setting module or unit 320.

The second communication unit 310 is configured to receive the physical layer signaling for activating or deactivating the HS-SCCH less operation mode from the network side (for example, base station).

The activation state setting unit 320 is configured to activate or deactivate the HS-SCCH less operation mode, according to the physical layer signaling for activating or deactivating the HS-SCCH less operation mode.

The HS-SCCH less operation mode indication bit may be preset in the UE, so as to instruct the UE to activate or deactivate the HS-SCCH less operation mode. The activation state setting unit 320 as shown in FIG. 3 includes at least one sub unit, namely, an activation setting sub module or sub unit 321 or a deactivation setting sub module or sub unit 322.

The activation setting sub unit 321 is configured to set the activation or deactivation indication bit of the HS-SCCH less operation mode to the value indicating performing the activation, according to the physical layer signaling for activating the HS-SCCH less operation mode, and activate the HS-SCCH less operation mode according to the activation indication of the indication bit. The deactivation setting sub unit 322 is configured to set the activation or deactivation indication bit of the HS-SCCH less operation mode to the value being different from the value indicating performing the activation, according to the physical layer signaling for deactivating the HS-SCCH less operation mode, and deactivating the HS-SCCH less operation mode according to the deactivation indication of the indication bit.

The particular manner of setting the activation or deactivation indicator may be obtained with reference to the embodiment of the method, and it is not repeated herein.

In the UE according to the present invention, the second communication unit 310 is further configured to return the acknowledgement message ACK to the network side. For example, the second communication unit 310 returns the ACK to the network side before or after the activation state setting unit 320 activates or deactivates the HS-SCCH less operation mode.

The HSDPA system according to the present invention includes the network side equipment and the UE in the above embodiment.

It may be known from the embodiment that the technical solution of controlling the working mode of the HSDPA system in the present invention is realized through the physical layer signaling. When the activation state of the HS-SCCH less operation mode needs to be changed, the physical layer signaling for activating or deactivating the HS-SCCH less operation mode is transmitted to the UE, the UE activates or deactivates the HS-SCCH less operation mode of the UE side, according to the physical layer signaling for activating or deactivating the HS-SCCH less operation mode. The physical layer signaling for activating or deactivating the HS-SCCH less operation mode may be preset and may also be generated after it is determined that the activation state of the HS-SCCH less operation mode needs to be changed. As compared with the solution in the prior art that the HSDPA system is made to enter or exit the HS-SCCH less operation mode by adopting the high-level signaling, the solution of the present invention that the HS-SCCH less operation mode is activated or deactivated by adopting the physical layer signaling has a higher speed, so as to quickly control the working mode of the HSDPA system, so that when the network side, for example, the NodeB, determines to deactivate the HS-SCCH less operation mode, the UE may quickly know the activation state of the HS-SCCH less operation mode of the current NodeB side, thereby preventing the meaningless complex determination, and saving the processing resources of the UE. On the other hand, the air interface resources are further saved in the configuration adopting the physical layer signaling as compared with the configuration adopting the high-level signaling interaction.

It may be understood by those of ordinary skill that the process of controlling the working mode of the HS-SCCH in the method according to the above embodiment may be finished through relevant hardware instructed by a program, in which the program may be stored in a readable storage medium of the base station and the UE, and the corresponding steps in the method are executed when the program is executed. The storage medium may be, for example, a read only memory (ROM)/random access memory (RAM), a magnetic disk, and an optical disk, etc.

It will be apparent to those skilled in the art that various modifications and variations can be made to the structure of the present invention without departing from the scope of the invention. In view of the foregoing, it is intended that the present invention cover modifications and variations of this invention provided they fall within the scope of the following claims and their equivalents.

What is claimed is:

1. A method for controlling a working mode of a high speed downlink packet access (HSDPA) system, the method comprising:
transmitting a physical layer signaling to a User Equipment (UE) to instruct the UE to activate or deactivate a high speed shared control channel (HS-SCCH) less operation mode if an activation state of the HS-SCCH less operation mode needs to be changed;
wherein the physical layer signaling comprises an HS-SCCH order indicating activating or deactivating of the HS-SCCH less operation mode; and
wherein an order type of an HS-SCCH order is set to 000 and a bit of the HS-SCCH order is set to a first value indicating activating the HS-SCCH less operation mode or set to a value different from the first value indicating deactivating the HS-SCCH less operation mode.

2. The method according to claim 1, wherein an Xord,3 bit of the HS-SCCH order is set to 1 to activate the HS-SCCH less operation mode or set to 0 to deactivate the HS-SCCH less operation mode, wherein the Xord,3 is a reservation bit of the HS-SCCH order.

3. The method according to claim 1, wherein the physical layer signaling comprises an order for activating or deactivating the HS-SCCH less operation mode in the HS-SCCH order, wherein the bit of the HS-SCCH order is set to a first value indicating activating the HS-SCCH less operation mode or set to a value different from the first value indicating deactivating the HS-SCCH less operation mode.

4. The method according to claim 1, further comprising generating the physical layer signaling or invoking the physical layer signaling for activating or deactivating the HS-SCCH less operation mode, when the activation state of the HS-SCCH less operation mode needs to be changed.

5. The method according to claim 1, wherein after transmitting the physical layer signaling, the method further comprises:
receiving an acknowledgement message (ACK) or a non-acknowledgement message (NACK) from the UE; and
if the ACK is received, activating or deactivating the HS-SCCH less operation mode of a base station side corresponding to the physical layer signaling transmitted to the UE.

6. The method according to claim 2, wherein after transmitting the physical layer signaling, the method further comprises:
receiving an acknowledgement message (ACK) or a non-acknowledgement message (NACK) from the UE; and
if the ACK is received, activating or deactivating the HS-SCCH less operation mode of a base station side corresponding to the physical layer signaling transmitted to the UE.

7. The method according to claim 4, wherein after transmitting the physical layer signaling, the method further comprises:
receiving an acknowledgement message (ACK) or a non-acknowledgement message (NACK) from the UE; and
if the ACK is received, activating or deactivating the HS-SCCH less operation mode of a base station side corresponding to the physical layer signaling transmitted to the UE.

8. A network side equipment, comprising:
a determining unit, configured to determine whether an activation state of an HS-SCCH less operation mode of an HSDPA system needs to be changed; and
a communication unit, configured to transmit physical layer signaling for activating or deactivating the HS-SCCH less operation mode to a UE to instruct the UE to activate or deactivate the HS-SCCH less operation mode;
wherein the physical layer signaling comprises an HS-SCCH order indicating activating or deactivating of the HS-SCCH less operation mode; and
wherein an order type of the HS-SCCH order is set to 000 and a bit of the HS-SCCH order is set to a first value indicating activating the HS-SCCH less operation mode or set to a value different from the first value indicating deactivating the HS-SCCH less operation mode.

9. The network side equipment according to claim 8, further comprising a signaling generating unit, configured to generate a physical layer signaling or invoke a physical layer signaling for activating or deactivating the HS-SCCH less operation mode, when the activation state of the HS-SCCH less operation mode needs to be changed.

10. The network side equipment according to claim 9, wherein the signaling generating unit comprises:
an activation signaling generating sub unit, configured to generate the physical layer signaling or invoke the physical layer signaling for activating the HS-SCCH less operation mode, when the HS-SCCH less operation mode needs to be activated.

11. The network side equipment according to claim 10, wherein the signaling generating unit further comprises:
a deactivation signaling generating sub unit, configured to generate the physical layer signaling or invoke the physical layer signaling for deactivating the HS-SCCH less operation mode, when the HS-SCCH less operation mode of the HSDPA system needs to be deactivated.

12. The network side equipment according to claim 9, wherein the signaling generating unit comprises:
a deactivation signaling generating sub unit, configured to generate the physical layer signaling or invoke the physical layer signaling for deactivating the HS-SCCH less operation mode, when the HS-SCCH less operation mode of the HSDPA system needs to be deactivated.

13. The network side equipment according to claim 8, wherein the network side equipment is a base station or part of a base station.

14. The network side equipment according to claim 8, wherein the communication unit is further configured to
receive an acknowledgement message (ACK) or a non-acknowledgement message (NACK) from the UE; and
activate or deactivate the HS-SCCH less operation mode of a network side corresponding to the physical layer signaling transmitted to the UE according to the ACK, if the ACK is received.

15. A method for controlling a working mode of an HSDPA system, the method comprising:
receiving a physical layer signaling for activating or deactivating an HS-SCCH less operation mode, the physical layer signaling received from a network side; and
activating the HS-SCCH less operation mode according to the physical layer signaling for activating the HS-SCCH less operation mode or deactivating the HS-SCCH less operation mode according to the physical layer signaling for deactivating the HS-SCCH less operation mode;
wherein the physical layer signaling comprises an HS-SCCH order indicating activating or deactivating of the HS-SCCH less operation mode; and
wherein an order type of the HS-SCCH order is set to 000 and a bit of the HS-SCCH order is set to a first value indicating activating the HS-SCCH less operation mode or set to a value different from the first value indicating deactivating the HS-SCCH less operation mode.

16. The method according to claim 15, wherein the method further comprises:
presetting an HS-SCCH less operation mode indication bit in a UE to instruct the UE to activate or deactivate the HS-SCCH less operation mode,
wherein activating the HS-SCCH less operation mode comprises setting the HS-SCCH less operation mode indication bit to a value indicating performing an activation according to the physical layer signaling, and activating the HS-SCCH less operation mode according to an activation indication of the indication bit; and
wherein deactivating the HS-SCCH less operation mode comprises setting the HS-SCCH less operation mode indication bit to a value being different from the value indicating performing the activation according to the physical layer signaling, and deactivating the HS-SCCH less operation mode according to a deactivation indication of the indication bit.

17. The method according to claim 15, wherein before the activating the HS-SCCH less operation mode or deactivating the HS-SCCH less operation mode, the method further comprises:
returning an acknowledgement message (ACK) to the network side.

18. A User Equipment (UE), comprising:
a communication unit, configured to receive a physical layer signaling for activating or deactivating an HS-SCCH less operation mode from a network side; and
an activation state setting unit, configured to activate or deactivate the HS-SCCH less operation mode according to the physical layer signaling for activating or deactivating the HS-SCCH less operation mode;
wherein the physical layer signaling comprises an HS-SCCH order indicating activating or deactivating of the HS-SCCH less operation mode; and
wherein an order type of the HS-SCCH order is set to 000 and a bit of the HS-SCCH order is set to a first value indicating activating the HS-SCCH less operation mode or set to a value different from the first value indicating deactivating the HS-SCCH less operation mode.

19. The UE according to claim 18, wherein an HS-SCCH less operation mode indication bit is preset in the UE to instruct to activate or deactivate the HS-SCCH less operation mode and the activation state setting unit at least comprises one of an activation setting sub unit or a deactivation setting sub unit,
wherein the activation setting sub unit is configured to set the indication bit of the HS-SCCH less operation mode to a value indicating performing the activation according to the physical layer signaling, and to activate the HS-SCCH less operation mode according to an activation indication of the indication bit; and
wherein the deactivation setting sub unit is configured to set the indication bit of the HS-SCCH less operation mode to a value being different from the value indicating performing the activation, according to the physical layer signaling for deactivating the HS-SCCH less operation mode, and to deactivate the HS-SCCH less operation mode according to a deactivation indication of the indication bit.

20. The UE according to claim 18, wherein the communication unit is further configured to return an ACK to the network side.
